(19) United States
(12) Patent Application Publication
(10) Pub. No.: US 2025/0265666 A1
(43) Pub. Date: Aug. 21, 2025

(54) SYSTEM AND METHOD FOR FACILITATING SERVICE OF PROCESS FOR LEGAL PAPERS

(71) Applicants: Kevin Scott Wyatt, Cottonwood Heights, UT (US); Michael Douglas Larsen, Cottonwood Heights, UT (US)

(72) Inventors: Kevin Scott Wyatt, Cottonwood Heights, UT (US); Michael Douglas Larsen, Cottonwood Heights, UT (US)

(21) Appl. No.: 19/054,823

(22) Filed: Feb. 15, 2025

Related U.S. Application Data
(60) Provisional application No. 63/554,137, filed on Feb. 15, 2024.

(51) Int. Cl. G06Q 50/18

(52) U.S. Cl. CPC G06Q 50/18

(57) ABSTRACT

A computer system facilitates service of process for multiple different clients and by multiple independent process servers. The process service system receives documents and data associated with service of process for a legal document and presents the process service job to multiple unaffiliated process servers. Process servers request jobs that they are available to fulfill and clients select process servers to complete their process service job based on process server location and availability and based on process server feedback and performance history.

### PRIORITY

The present application claims the benefit of U.S. Provisional Application Ser. No. 63/554,137, filed Feb. 15, 2024, which is herein incorporated by reference in its entirety.

### THE FIELD OF THE INVENTION

The present invention relates to legal service of process. In particular, examples of the present invention relate to a computer implemented system for allowing persons needing to serve legal papers to match their case with available process servers, transmit documents to process servers, and receive electronic verification that the papers have been served.

### INTRODUCTION

Legal proceedings such as lawsuits typically require that legal papers are served to parties in the lawsuit. Service typically requires that a third party pick up papers from the originating party, locate the receiving party and deliver the papers, obtain a signature upon delivery of the papers, and provide proof of service to the court.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a schematic which shows a computer system used to provide electronic service of process;

FIG. 2 is a flowchart diagram of a method of electronic service of process for legal documents;

FIG. 3 is a drawing of a process server computer interface used to facilitate electronic service of process.

FIG. 4 is a drawing of a process server computer interface used to facilitate electronic service of process.

FIG. 5 is a drawing of a process server computer interface used to facilitate electronic service of process.

FIG. 6 is a drawing of a process server computer interface used to facilitate electronic service of process.

FIG. 7 is a drawing of a process server computer interface used to facilitate electronic service of process.

FIG. 8A is a drawing of a client computer interface used to facilitate electronic service of process.

FIG. 8B is a drawing of a client computer interface used to facilitate electronic service of process.

FIG. 9 is a drawing of a client computer interface used to facilitate electronic service of process.

FIG. 10 is a drawing of a client computer interface used to facilitate electronic service of process.

FIG. 11 is a schematic drawing which shows a computer used to implement the process service system.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Embodiments may also be implemented in cloud computing environments. In the description and claims, “cloud computing” may be defined as a system for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud system can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). The flowchart or process steps may be performed in alternate order so long as the change in order does not materially alter the result. Each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

As used herein, “adjacent” refers to near or close sufficient to achieve a desired effect. Although direct contact is common, adjacent can broadly allow for spaced apart features. As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be one or two significant digits above or one or two significant digits below the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

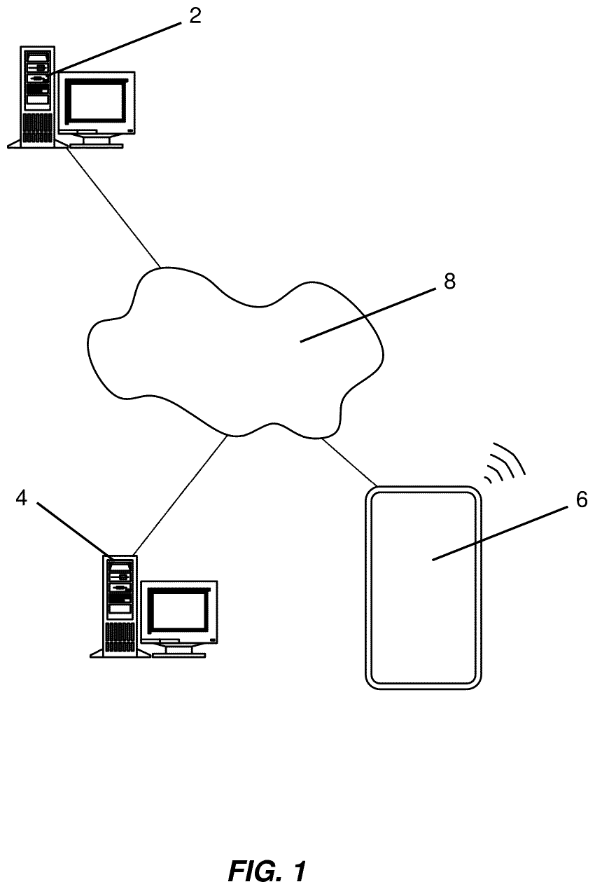

FIG. 1 illustrates an example computer system which may implement the process service system described herein. In one example, the process service system may be implemented on a computer 2. Computers may include traditional computers as well as computers such as tablet and mobile computers and smart phones. The computer 2 is operated by a company which provides service of process to clients. The computer 2 stores the software and data necessary to implement the process service system and performs the calculations and processes discussed herein. The computer 2 transmits and receives information from one or more client computers 4 which facilitates user input and presents process service system information to the client user via a user interface. Client computers 4 are operated by clients such as law firms who are seeking service of process for documents such as legal documents for court proceedings. The computer 2 receives documents requiring service of process as well as information regarding the service of process such as the document recipient, address, case information, etc. electronically from the client computer 4. The computer 2 also communicates with one or more process server computers 6. Process server computers 6 are operated by process servers who provide service of process for the clients via the company and process service system discussed herein. The individual process servers may work independently from the company as independent contractors while provided service of process for documents obtained through the company and through the process service system. Process server computers 6 are frequently mobile computers which allow the process servers to capture and enter data regarding the service of process on location.

The computer 2 provides process service information and documents to the process server computers and facilitates service of process by a process server associated with the process server computer 6. The computer 2 receives information confirming service and proof of service from the process server computer 6. The computer 2 communicates with client computers 4 and process server computers 6 over the internet 8 and via a secure connection. It is appreciated that many of the steps discussed herein may be provided by the computer 2 with client computers 4 and process server computers 6 acting largely as user interfaces to transmit and receive data to and from the computer 2. In other examples, some computational steps may be performed by the client computers 4 or process server computers 6, changing the distribution of computational tasks between the computers 2, 4, 6 in operating the process service system. It is also appreciated that the computational steps performed by the computer 2 may be distributed among multiple computer servers 2 as is optimal for handling the system computational load.

In describing the present system, some reference is made to actions taken by a third party such as a client with legal documents that need service or a process server who will serve the legal documents. Clients typically interact with the computer 2 via a client computer 4 and process servers typically interact with the computer 2 via a process server computer 6. It is understood that when an action or step is described from the client or process server viewpoint a corresponding complementary step is taken by the computer server. Thus, a client or process server entering or transmitting data is accompanied by the computer 2 receiving the data. A client computer 4 or process server computer 6 displaying a screen or data is accompanied by the computer 2 presenting the data. In this manner, it is understood that the computer 2 receives data, stores data, calculates and processes data, transmits data, and presents data to facilitate operation of the process service system and that the client computer 4 and process server computer 6 are used as interfaces to interact with the computer 2.

In describing the present system, the functionality is described with respect to a single example client using a client computer 4 and a single example process server using a process server computer 6. It is appreciated that the process service system is designed to serve multiple distinct clients and to facilitate service of process by multiple unaffiliated process servers. The process servers include various different independent process servers that are not affiliated with the company providing the process service system and process servers that are not all affiliated with each other as part of a company. Clients are provided efficient service by allowing automatic contact of multiple different process servers and by choosing among process servers to select one with good ratings and a good service record and also with good availability to complete the job based on location and other factors.

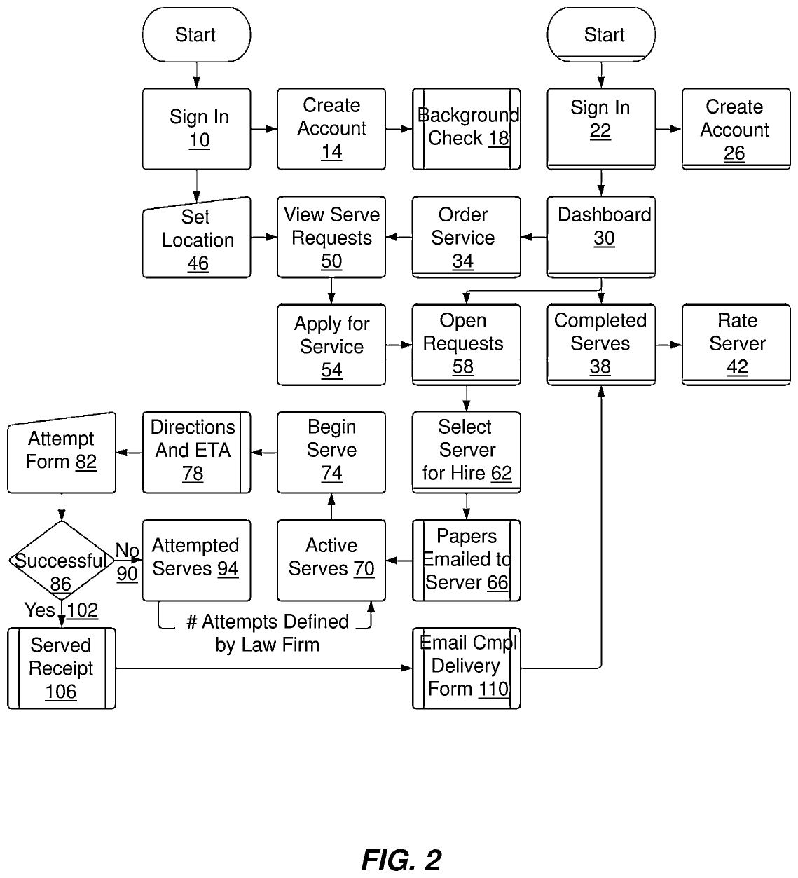

FIG. 2 shows a flowchart for a computer system that is used to facilitate service of process for legal papers. A computer 2 facilitates service of legal papers from a client by a process server. In the flow chart, squares with vertical lines down their sides depict process steps that are typically performed by the computer 2. Squares with horizontal lines across the bottom of the square depict process steps that are typically performed via a client computer 4 that is communicating with the computer 2. Other squares depict process steps that are typically performed via a process server computer 6 that is communicating with the computer 2. The computer 2 facilitates service of process for legal papers by electronically receiving, processing, and transmitting data comprising legal papers and service instructions from a client and by electronically receiving, processing and transmitting service results and proof of service from a process server.

A process server may use a process server computer 6 such as a portable computer or smart phone to sign in 10 to an account on the computer 2 and the computer 2 authenticates the process server account and receives data from the process server computer 6. A secure connection is created between the computer 2 and the process server computer 6. If the process server is new to the system, the process server can create an account 14 on the computer and will enter required identifying information which is received by the computer 2. Process server account information may include the person's legal name, age, date of birth, government issued identification, background check information, licensing information, areas where the person is willing to work, times when the person is available to work, and banking or payment information. Once sufficient information has been received by the computer 2, the computer 2 will cause a background check to be completed 18 to verify the process server's credentials and to verify that the process server is suitable to effect service of process of behalf of the company and on behalf of the clients. The computer 2 stores account information pertaining to the process server and exchanges information with the process server computer 6. Once an account is created and a process server is validated and ready to serve legal papers, the process server may sign into their account 10 and select process service jobs to complete.

Clients such as law firms or other individuals and companies requiring service of legal papers may use a client computer 4 to sign in 22 to an account on the computer 2. A secure connection is created between the computer 2 and a client computer 4 when a client signs into the service of process system. If the client is new to the process service system, the client can create an account 26 and will enter required identifying information which is received by the computer 2. Client account information may include a company name or a person's legal name, contact information, type of business, and payment information. Once sufficient information has been received by the computer 2, the computer 2 will create a client account 26. The computer 2 stores account information pertaining to the client. The computer 2 receives information and exchanges information with the client computer 4 to facilitate service of process of legal papers and documents on behalf of the client. Once an account is created, the client may sign into their account 22 and initiate process service jobs to complete.

When a client signs into their account 22 on the computer 2, the computer 2 displays a dashboard 30 to the client. The client dashboard allows the client to perform tasks associated with requesting service of process and thereby transmit data to the computer 2. The computer 2 may receive a request for service of process 34 from a client. In requesting service of process, the computer 2 will electronically receive a document (e.g. a legal document formatted in a pdf or word or text based document format) for service and information regarding service of process from a client computer 4. The information regarding service of process will typically include the name and address of the person who needs to be served with the document as well as additional information regarding the service of process. The computer 2 will typically receive and store the document which is to be served on the person in electronic format. The computer 2 may also receive from the client computer 4 a selection of certain parameters regarding the desired service of process. The computer 2 may receive a selection of a date range or time period during which service of process must occur, or times during the day when service should be attempted as well as relevant information about the person who is to be served with the document and requirements for confirming service of process. The computer 2 may receive from the client computer 4 selections regarding the service of process such as how many times the service of process may be attempted.

A client may also use the client dashboard 30 to manage other aspects of process service. The computer 2 may display, via the dashboard and via the client computer 4, completed service of process requests 38 and may display information about completed service of process requests to the client such as by displaying the documents that were served, the person that was served the documents, the process server that completed service of process, the date and time that the documents were served, the cost of service, and proof of service of process. The computer 2 may allow the client to rate 42 the process server that completed service of process and receive the rating from the client computer 4. The system allows independent process servers to provide service of process by serving papers for clients, and obtaining and displaying ratings for process servers allows clients to make better informed decisions about selecting a process server to serve documents.

When a process server signs into their account on the computer 2, the process server may set a location 46 that they are working in and the computer 2 receives data from the process server computer 6 regarding the selection. In one aspect, the process server may set a location that they work in under general circumstances. In another aspect, the process server may set a different or temporary location 46. A process server may take a process serving job in a different location such as an adjacent city or may desire to work in a different location for a time and may set a temporary location 46 for that city to perform additional process serving jobs while in that location.

The computer 2 may display serve requests to the process server so that the process server can view available requests 50 for service of process via their process server computer 6. The computer 2 may display information about the service of process requests such as the location for the service of process, the type of document being served, the time period during which service of process must be completed, handling of multiple attempts for service of process, and the payment amount for completion of the service of process. As the computer 2 provides process servers with a list of available process service jobs and provides electronic access to the legal documents that need to be served, the computer 2 facilitates quick and efficient service of process. Process servers may obtain easy access to process service jobs and documents while on location for service of process; allowing the process servers to complete multiple process service jobs while at a location rather than traveling back and forth between an office and process service job locations. Service of process jobs are completed more quickly for the clients and with less burden on the process servers. The process server may apply 54 to perform service of process for open service of process requests 58 via their process server computer 6 and via the computer 2.

Clients may view and the computer 2 may display open requests 58 via the client computer 4. The computer 2 may receive change instructions from a client for open service requests 58 to change parameters associated with the service of process job such as the time period of service, payment amount for service, etc. The computer 2 may also receive from the client computer 4 a selection 62 of a process server to complete the service of process job. Multiple process servers may apply 54 to complete the service of process job and the client may select 62 a desired process server based on availability, location, feedback, etc. With selection 62 of a process server for a service job, the computer 2 may assign the service job to the process server and make the service job available to the process server in their account and via process server computer 6. The computer 2 may email 66 papers to the process server for service of process or may alternatively may make the papers available for download by the process server computer 6 through the process server account and thereby transmit the legal papers to the process server computer 6.

The computer 2 may display 70 active process service jobs to the process server via process server computer 6. The computer 2 may receive from the process server an instruction or selection to begin 74 service of process for an active process service job. The computer 2 may display 78 to the process server via the process server computer 6 directions to the residence or other location where the recipient of the served legal papers is expected to be, such as by displaying the location of a residence of workplace in a map and displaying directions to the location on the map via process server computer 6. The computer 2 receives from the portable process server computer 6 (such as a smart phone 6) GPS location of the process server computer 6. From the GPS location data and time data, the computer 2 tracks the location of the server computer 6 and thereby tracks and records the progress of the attempted service of process. The computer 2 may use GPS data and time data to demonstrate the occurrence and validity of service of process. GPS data and time stamp data may be recorded by the computer 2 when the document is served, when a photograph of service is taken, and when a signature accepting or confirming service is obtained. The computer 2 may present to the process server a service attempt form 82 where the process server may indicate to the computer 2 whether service was successful. The computer 2 receives, via the process server computer 6, indication 86 of whether the service of process was successful or not successful. If service was not successful 90, the computer 2 may track and record 94 the number of attempts to complete service of process for the job. The computer 2 receives and stores an allowed number of service attempts 98 from the client and determines if the allowed number of service attempts 98 has been met for the service job. If the allowed number of service attempts 98 has not been met, the computer 2 returns the service job to active serves 70 assigned to the process server.

If the computer 2 receives, via the process server computer 6, indication 86 that the service of process was successful 102, the computer 2 receives and stores 106 proof of service from the process server computer 6. The computer 2 may receive and record the GPS location of the process server computer 6 and time of day for service of process events such as by recording when service of process occurred, where service occurred, a photograph or other image is captured during service of process, a signature of the recipient of the served legal papers is obtained, and additional data to verify that service of process was properly completed is obtained. In one example, the person receiving the legal papers may sign to indicate receipt of the legal papers on the process server's computer 6 and the computer 2 may receive from the process server computer 6 the recorded signature, the GPS data of where the process server computer 6 is located when the signature was obtained, and time stamp data of when the signature was obtained. The computer 2 may transmit 110 confirmation of service of process to the client such as by emailing confirmation of service to the client or by making the confirmation of service available to the client via the client account/dashboard 30 and via the client computer 4. The computer 2 may transmit confirmation of service data including a photo confirming service, a signature confirming service, and process server computer GPS data and time stamp data for: when service was indicated as complete, when the document was transmitted to the recipient, when the photo was taken, and when the signature was obtained. The computer 2 may then record the process service job as a completed service of process 38 and so indicate in the client account. Once service of process is complete, the computer 2 may receive payment from the client, such as by initiating transfer from a client bank account to a company back account or by invoicing the client for the service of process. Payment for the service of process may include itemized fees for service of process, attempted service of process, mileage, aggressive recipient, etc. and may also include fees for the company facilitating the service of process. The computer 2 may transmit payment to the process server by initiating payment from a company bank account to a process server bank account.

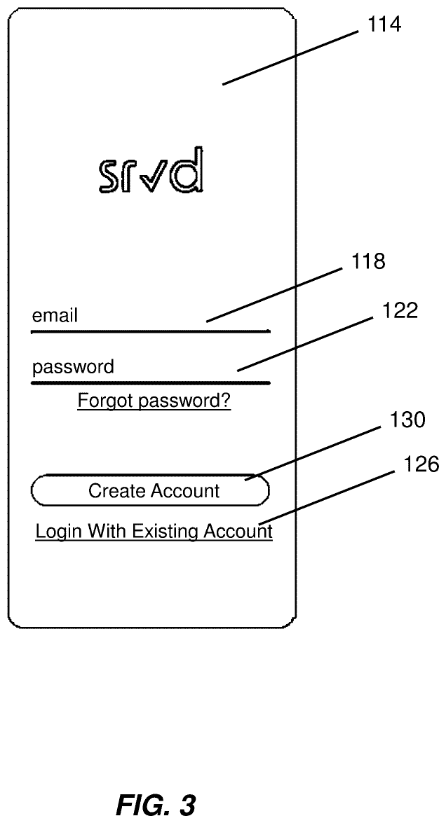

FIGS. 3 through 7 show display screens presented to a process server by the computer 2 via a process server computer 6. The screens allow the computer 2 to present information to a process server and to receive information from the process server via the process server computer 6 with the process server computer forming a user interface between the computer 2 and the process server.

FIG. 3 shows a drawing of a login screen 114 displayed on a process server mobile phone computer 6. The login screen 114 includes text fields 118 and 122 to allow a user to enter their account email (or login ID) and password and a button 126 to login 10 to the account. A button 130 to create an account is also provided. Pressing the create an account button 130 allows the user to provide an email address, password, and other necessary data to create an account 14 with the process service system.

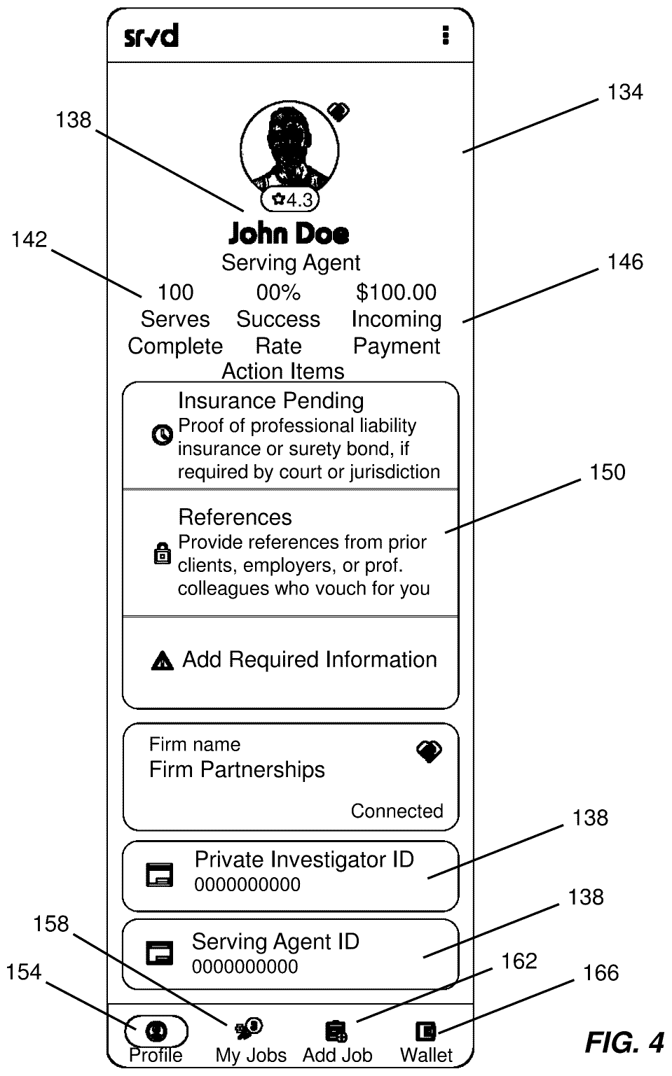

FIG. 4 shows a drawing of an account home screen 134 for a process server using the process service system via a cell phone computer 6. The home screen 134 includes account identifying information 138 for the account/process server such as name, photograph, and identification numbers or license numbers. The home screen may also include statistical information 142 such as the number of service of process jobs that have been completed or the success rate in completing service of process jobs. The home screen 134 may include earnings information 146 such as incoming payments for recently completed jobs. The home screen 134 may include action item notifications 150 for tasks that need to be completed by the process server, such as providing proof of insurance or references. Each action item notification may be a button that navigates to an associated screen within the process service system to complete the action item when the button is clicked. The home screen 134 may also include buttons to navigate to a profile screen 154, assigned jobs 158, add jobs 162, and to a wallet 166.

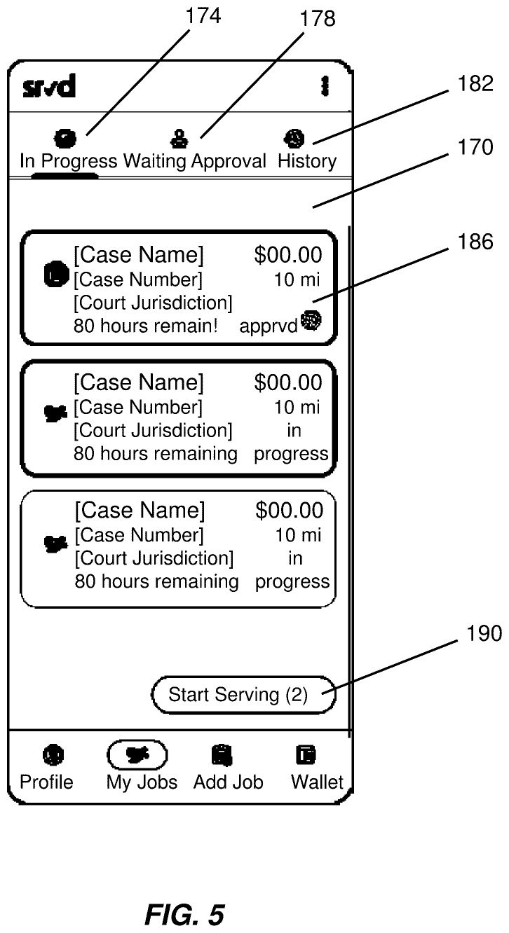

FIG. 5 shows a drawing of an assigned jobs screen 170. The assigned jobs screen 170 includes tab buttons to show in progress jobs 174, jobs waiting approval 178, and a history of past jobs 182. Each of these tab buttons changes the screen to show detains about jobs that fall into the selected category. Jobs are displayed with a small data box/tile 186 that provides information about the job, such as a case name, number, and jurisdiction, time remaining to complete the service of process job, job approval status, distance to the location for service of process, and the price paid upon completion of the job. A process server may press/interact with the job tiles 186 to select one or more jobs and then press a start button 190 to start working on these jobs.

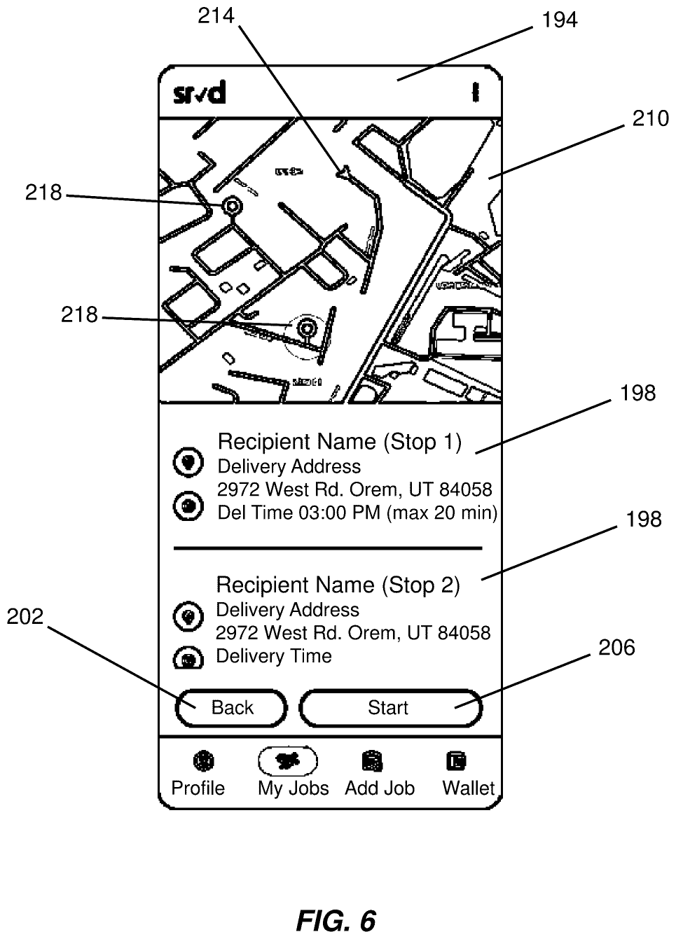

FIG. 6 shows a drawing of an active serves screen 194. The active serves screen 194 includes one or more data tiles 198 that provide information about the process service jobs that have been selected. Each data tile 198 may include a recipient name, delivery address, and delivery time for the process service job. The data tile 198 may also include job identifying information that links the recipient to a particular process service job or document. The active serves screen 194 includes a back button 202 that allows a process server to navigate back to the assigned jobs screen to select different process service jobs to complete. The active serves screen 194 includes a start button 206 that guides the process server through completion of the selected process service jobs. The active serves screen 104 includes a navigation window 210 that displays a map showing the location of the process server 214 and the location(s) of the document recipients 218 associated with the selected process service jobs. Once the process server has pressed the start button 206, the computer 2 may provide navigation instructions to the process server via audio instructions and via the navigation window 210 and may provide other instructions necessary for completion of the process service job. When a process server completes a job, they may press the job data tile and indicate that the job has been completed. The process server may enter confirming information such as GPS data regarding the service of process event, time of the process service event, a response by the person receiving the document via service of process, photographs of the process service event, and a process server declaration regarding completion of service of process. This information is received by and stored by the computer 2 and provided to the client as proof of service of process. The computer 2 may automatically receive information validating service of process such as GPS and time stamp data regarding the attempted or completed service of process, recipient signature, or photographic evidence of service of process from the process server computer 6.

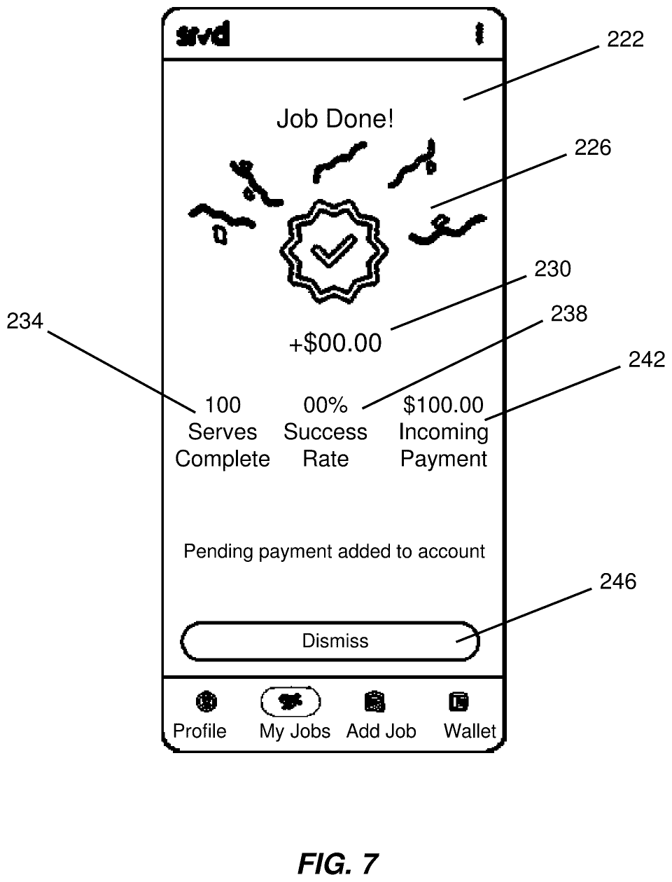

FIG. 7 shows a drawing of a job completion screen 222. The job completion screen 222 displays a graphical element 226 to indicate that a process service job has been completed and may display the payment amount 230 associated with the process service job. The job completion screen 222 may also display a tally of completed jobs 234, a percentage success rate 238 for process service jobs assigned to the process server, and an upcoming payment tally 242 for recently completed process service jobs.

Information entered into the process server computer 6 is transmitted to the computer 2 and the computer 2 receives and stores the entered information. The computer 2 confirms completion of service of process with the received information and presents confirmation and proof of service of process to the client that requested the service of process job.

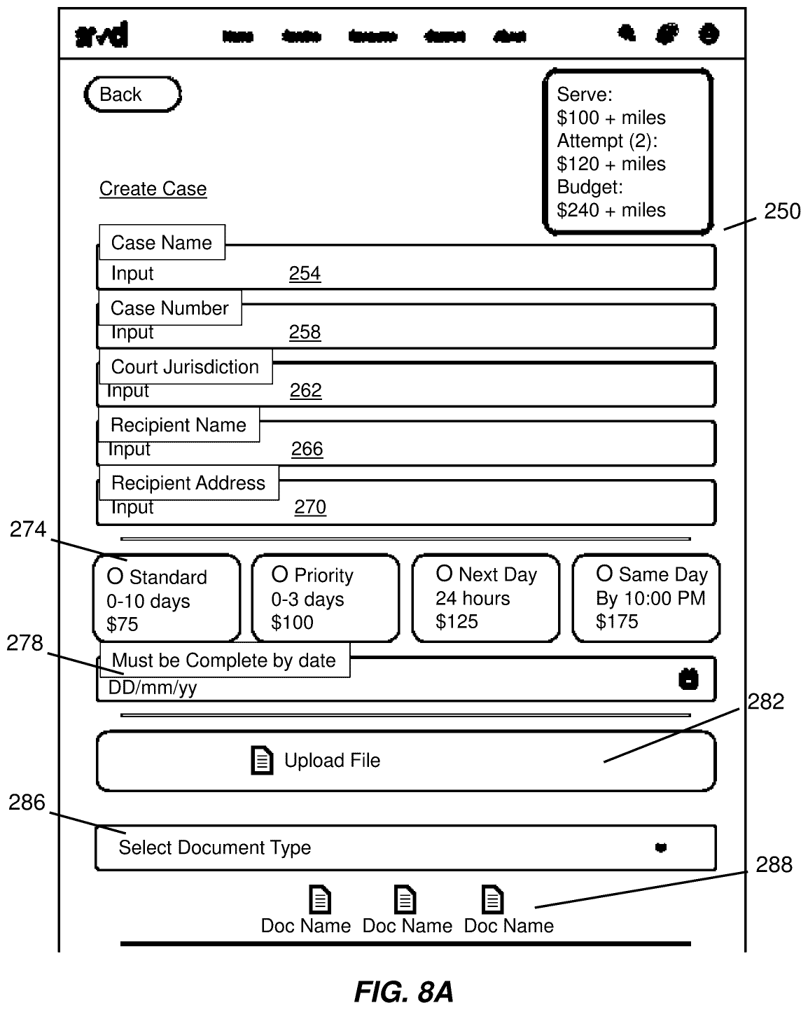

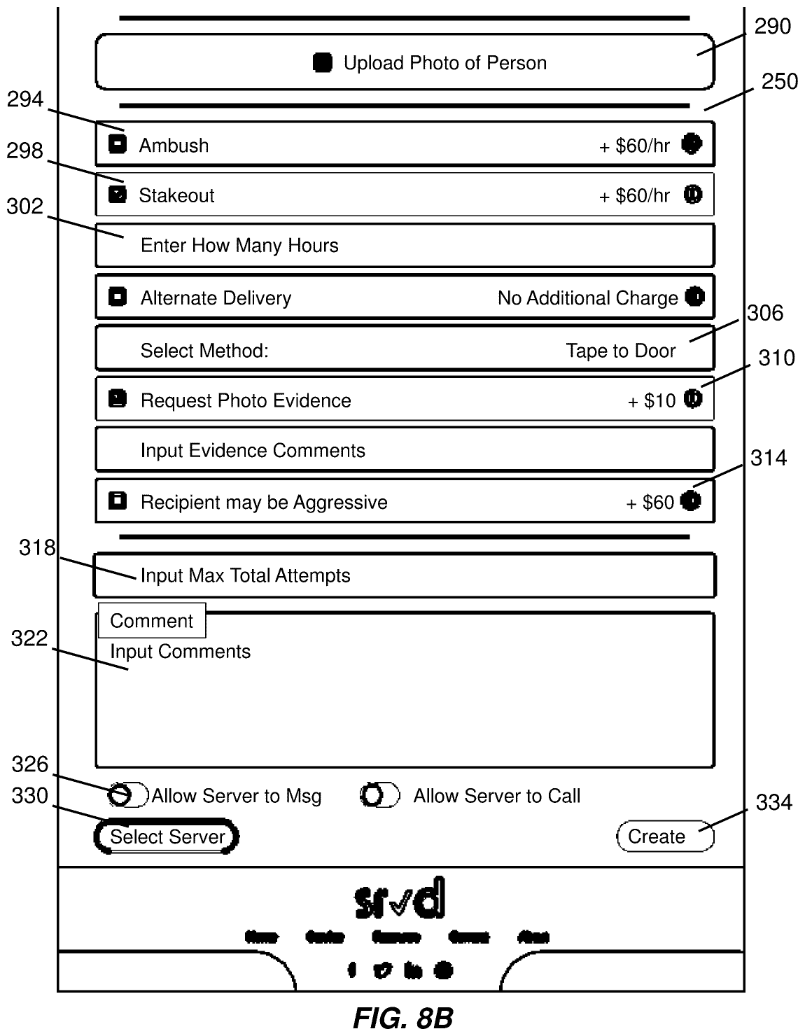

FIGS. 8 through 10 show display screens presented to a client by the computer 2 via a client computer 4. The screens allow the computer 2 to present information to a client and to receive information from the client via the client computer 4 with the client computer 4 forming a user interface between the computer 2 and the client.

FIGS. 8A and 8B show drawings of a client case creation screen 250 that allows a client to order service of process 34 for a legal document. The screen is split between two drawings to facilitate illustration of the screen contents. The case creation screen 250 includes text boxes that allow a client to enter a case name 254, case number 258, court jurisdiction 262, recipient name 266 and recipient address 270. The case creation screen 250 includes radio buttons 274 that allow the client to select a type of process service such as standard service, priority service, next day service, or same day service. The radio buttons 274 present pricing for each type of service and allow the client to select one type of service. The case creation screen 250 includes a data field 278 that allows the user to enter a date by which service of process must be completed. An upload file button 282 allows a client to upload the document or documents that need to be served to the document recipient and a dropdown list 286 allows the client to select the type of documents that have been uploaded. The computer 2 may display 288 the documents that have been uploaded.

The case creation screen 250 also includes an upload file button 290 that allows the client to upload a picture of the document recipient to allow the computer 2 to receive the picture and to show the picture of the document recipient to the process server via process server computer 6. The case creation screen 250 includes checkboxes that allow the client to select additional types of service such as “ambush” service 294 where a process server is authorized to wait for the document recipient to exit an anticipated location such as a work location to serve the person at that time or “stakeout” service 298 where a process server is authorized to wait for a document recipient to appear at a location. A data input field 302 allows the client to set a maximum time limit that a process server is authorized to wait for a document recipient. A checkbox 306 allows the client to authorize alternative delivery and to specify a type of alternative delivery such as taping the document to a door. The case creation screen 250 includes a checkbox 310 to request photo evidence of service of process and to allow the client to specify the type of photo evidence that is desired or to otherwise enter comments regarding the evidence of service of process. The case creation screen 250 includes a checkbox 314 to alert the process server that the document recipient may be aggressive. The case creation screen 250 includes a text box 318 to allow the client to select a maximum number of service attempts and a text box 322 to allow entry of additional comments relevant to the service of process. Toggle buttons 326 are provided to allow the client to allow the process server to message the client or to call the client. A button 330 allows the client to select a preferred process server. A button 334 creates the process service job once necessary information has been entered. The computer 2 receives information from the client computer 4 via the case creation screen 250 to allow creation of the process service job request by the computer 2.

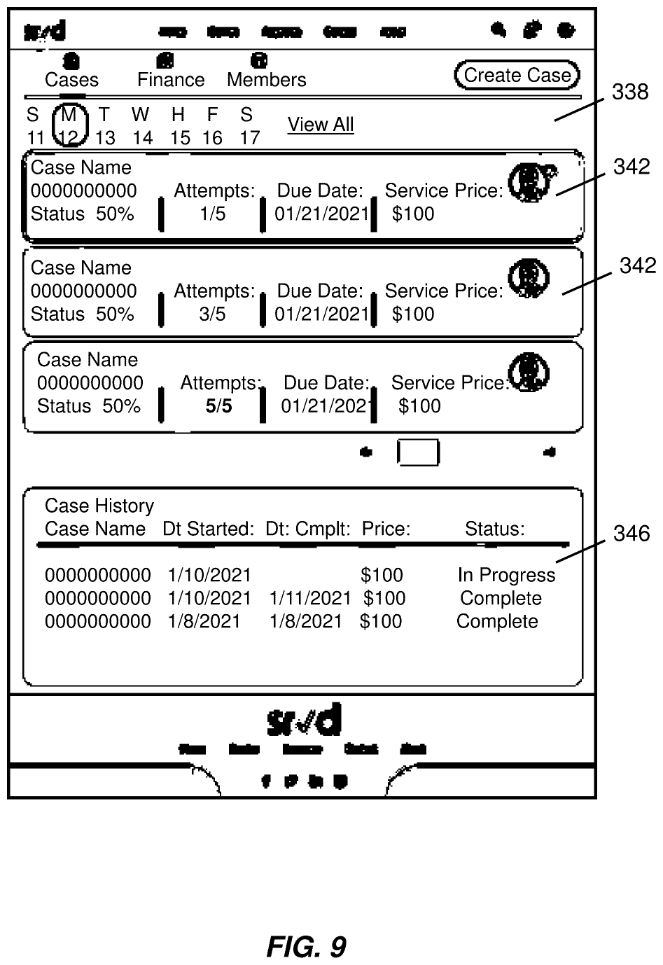

FIG. 9 shows a case management screen 338 which displays process service requests 58 pertaining to a particular client. The case management screen 338 displays data tiles 342 for open process service requests (jobs). If desired the case management screen may show data tiles 342 for completed process service requests or complete service of process requests may be displayed on a separate screen or tile for completed process service requests 38. Each data tile 342 for a process service request displays information about the process service request such as case identifying information, process service progress or status, attempts at service of process, the entered due date for service of process, and the service of process job cost. A case history tile 346 may be displayed. The case history tile may display completed process service jobs and may display a case number, date requested, date completed, and price for each completed service of process request. A client may select/click on a data tile or case identifier to view a case summary page displaying the process service results and proof of service of process information.

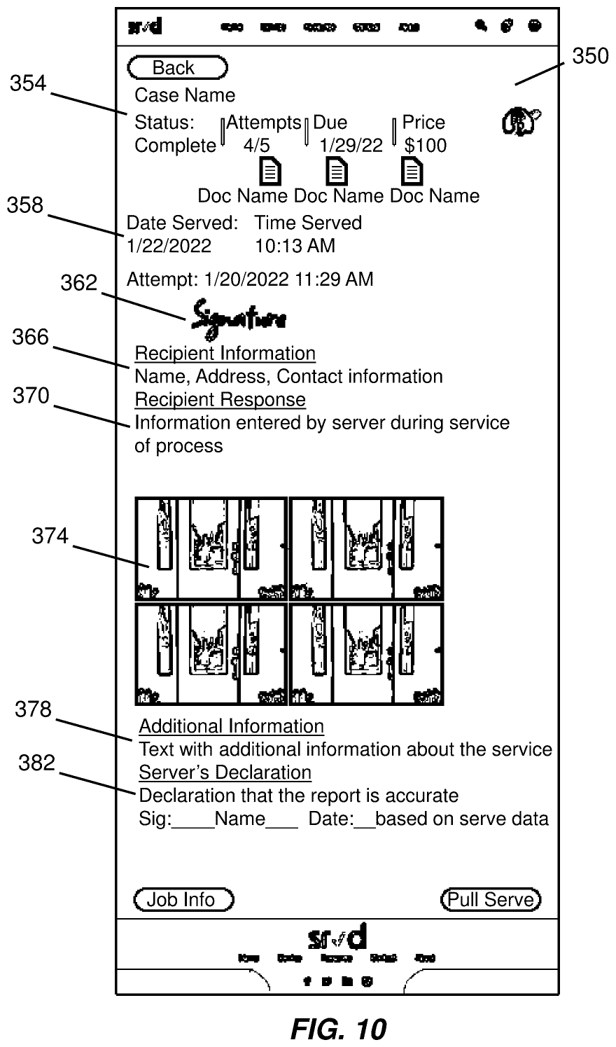

FIG. 10 shows a drawing of a case summary page 350 for a completed process service job. The case summary page 350 includes data fields 354 that display the case information and status information such as the service status, number of attempts to complete service of process, the deadline for service of process, and the job price, and data fields 358 that display the process service information such as the date and time that service of process was completed. These data fields may display the case identification, number of attempts at service, dates and times of attempts at service of process, date of successful service of process, and time of successful service of process, and may also display the GPS coordinates of the process server mobile computer 6 when service of process was completed. The case summary page 350 displays a signature 362 of the document recipient that was obtained electronically when service of process was completed. The signature may be obtained electronically via digital capture by the process server's computer 6. The case summary page 350 also displays the document recipient information 366 such as the recipient's name, address, and contact information for the document recipient. The case summary page 350 may also display a document recipient response 370 which may be a recorded response from the recipient or a response summary prepared by the process server. Supporting evidence 374 such as photographs that document the service of process may be transmitted to the computer 2 via the process server computer 6 and are presented to the client on the case summary page 350 via the client computer 4. The case summary page 350 may also include any additional information 378 entered by the process server and a declaration 382 by the process server that declares the date, time, and conditions of the completion of the service of process. For completed process service cases, the computer 2 transmits to the client computer 4 proof of service as required by courts to verify that the document was properly served to the document recipient.

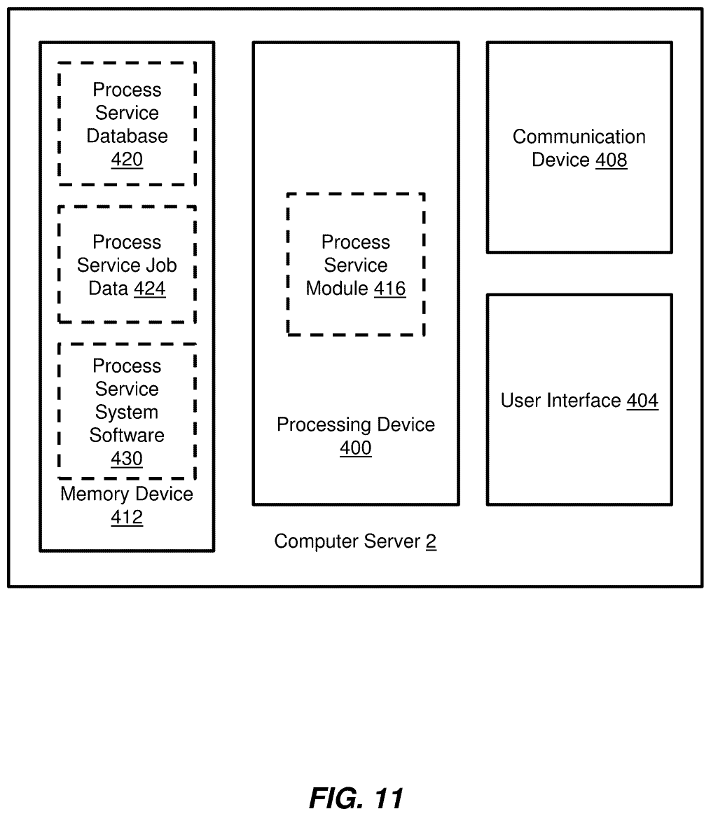

Referring now to FIG. 11, a schematic illustrating example components of the computer 2 is shown. In one example, the computer 2 includes a processing device 400, a user interface 404, a communication device 408, and a memory device 412. It is noted that the computer 2 can include other components and some of the components are not required in every example.

The processing device 400 can include memory, e.g., read only memory (ROM) and random access memory (RAM), storing processor-executable instructions and one or more processors that execute the processor-executable instructions. In embodiments where the processing device 400 includes two or more processors, the processors can operate in a parallel or distributed manner. The processing device 400 can execute the operating system of the computer 2. In the illustrative example, the processing device 400 may also execute a software module 416 such as a process service module 416.

The process service module 416 allows the computer 2 to communicate with a client computer 4 and with a process server computer 6 and to complete various processing and storage tasks associated with the process service module system described herein. The process service module 416 allows the computer 2 to receive account and server information from a process server computer 6. The process service module 416 allows the computer 2 to receive process service job information and legal documents from a client computer 4 as described herein to thereby create process service requests (jobs). The process service module 416 allows the computer 2 to communicate a plurality of different process service jobs to a number of different unaffiliated process servers via various process server computers 6. The process service module 416 allows the computer 2 to receive requests from process server computers 6 for process servers to complete process service jobs. The process service module 416 allows the computer 2 to provide a list of available service of process jobs to a number of process server computers 6. The process service module 416 allows the computer 2 to receive a selection of a process server from a client via a client computer 4 to have the selected process server complete a process service job. The process service module 416 allows the computer 2 to transmit, to a process server computer 6, legal documents to be served, an electronic photograph of the person designated to receive the legal documents, instructions specific for serving the document to the person, a location for the person, and real time directions to the person on a map that displays the person's anticipated location and the process server's location. The process service module 416 allows the computer 2 to receive real time data from a process server computer 6 to track a service of process job. The process service module 416 allows the computer 2 to receive, from a process server computer 6, GPS location data and time stamp data for: an attempt at service of process, successful service of process, capture of a digital photograph demonstrating service of process, and an electronically captured signature confirming service of process. The process service module 416 allows a computer 2 to receive service of process attempt and completion data from the process server computer 6 including GPS and time stamp data, signature data, photographic evidence, and declaration data. The process service module 416 allows the computer 2 to provide proof of service of process data to clients via client computer 4 including an electronic photograph documenting service of process, a signature documenting service of process, GPS location data for service of process and for service documentation events, and time stamp data for service of process and service of process documentation events. The process service module 416 may perform the various tasks discussed herein.

The user interface 404 is a device that allows a user to interact with the computer 2. While one user interface 404 is shown, the term “user interface” can include, but is not limited to, a local computer or a remote computer and parts thereof such as a touch screen, a physical keyboard, a mouse, a microphone, and/or a speaker. The computer user interface 404 allows for management of the process service system. The communication device 408 is a device that allows the computer 2 to communicate with another device; such as client computer 4 and process server computer 6. The communication device 408 can include one or more wireless transceivers for performing wireless communication and/or one or more communication ports for performing wired communication. The communication device 408 communicates remotely with the process server computers 6 and client computers 4 via the internet. The communication device 408 presents the system client interface to the client via client computer 4 and allows the client to request service of process and to perform other functions related to service of process. The communication device 408 presents the system process server interface to the process server via process server computer 6 and facilitates the service of process by providing documents and data to the process server computer 6 and receives confirmation of service of process information from the process server computer 6 to create, record, and provide proof of service of process for completed jobs.

The memory device 412 is a device that stores customized software programming to thereby implement the process service system described herein. The memory device 412 also stores data generated or received by the computer 2 by the process service system and may provide data to the processing device 400. The memory device 412 can include, but is not limited to, a hard disc drive, an optical disc drive, and/or a flash memory drive. The memory device 412 may include a process service database 420 which stores data regarding service of process requirements, options, and other data necessary to implement the process service system described herein. The processing device 400 may be used to create the process service database 420 and to facilitate calculations performed by the process service system. The memory device 412 may also include service of process job data 424 including served documents, document recipient data, service of process data, and other recorded data which may be used by the computer 2 to provide proof of service and related data. The memory device 412 may also store process service system software 430. The memory device may also have other tables, databases, or modules as are necessary to implement the various tasks and examples discussed herein.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, voltages, currents, frequencies, power range values, times, etc., are provided for explanation purposes and that other values may also be employed in other examples in accordance with the teachings of the present invention.

What is claimed is:

1. A computer implemented method for service of process for legal documents comprising:
a computer having a processor and memory receiving an electronic request to complete legal service of process of a document to a human document recipient from a client computer, the request comprising information identifying a human document recipient;
the computer receiving a legal document electronically from the client computer;
the computer transmitting the legal document electronically to a mobile process server computer;
the computer transmitting instructions regarding service of process to the process server computer;
the computer receiving electronic confirmation of service of process from the process server computer to confirm completion of service of process of the legal document to the document recipient, the electronic confirmation of service of process comprising a date of completion of service of process, a time of completion of service of process, and GPS location data for the process server computer when service of process occurred; and
the computer transmitting to the client electronic proof of service of process, the electronic service of process comprising a date of completion of service of process, a time of completion of service of process, and GPS location data for the process server computer when service of process occurred.

2. The method of claim 1, further comprising:
the computer displaying the service of process request to a plurality of unaffiliated process servers via a plurality of mobile process server computers;
the computer receiving, from a process server computer, an application to complete the service of process request by serving the legal document to the document recipient;
the computer electronically transmitting information regarding a process server applicant to the client computer;
the computer receiving, from the client computer, an electronic selection of a process server to complete the service of process request; and
the computer transmitting electronic notification of acceptance of the service of process request to the process server computer associated with the selected process server.

3. The method of claim 1, further comprising:
the computer displaying, via the process server computer, a map showing the process server location and showing the document recipient location.

4. The method of claim 3, further comprising:
the computer transmitting, to the process server computer, navigation instructions to lead the process server to the document recipient in real time.

5. The method of claim 1, further comprising:
the computer obtaining GPS location data of the process server computer in real time while the process server is in the process of serving the legal document to the document recipient.

6. The method of claim 1, further comprising:
the computer receiving, from the process server computer, a signature obtained electronically during completion of service of process; and
the computer transmitting, to the client computer, the electronic signature as evidence of completion of service of process.

7. The method of claim 6, further comprising:
the computer receiving, from the process server computer, GPS data and time data corresponding to the signature; and
the computer transmitting, to the client computer, the GPS data and time data as evidence of completion of service of process.

8. The method of claim 1, further comprising:
the computer receiving, from the process server computer, photographic evidence of completion of service of process; and
the computer transmitting, to the client computer, the photographic evidence as evidence of completion of service of process.

9. The method of claim 8, further comprising:
the computer receiving, from the process server computer, GPS data and time data corresponding to the photographic evidence of service of process; and
the computer transmitting, to the client computer, the GPS data and time data as evidence of completion of service of process.

10. The method of claim 1, wherein the electronic request to complete legal service of process comprises, a document recipient address, a selection of how service of process for a legal document is to be completed, an electronic photo of the document recipient, and a selection of timing options for completing service of process.

11. A computer implemented method for service of process for legal documents comprising:
a computer having a processor and memory receiving,
the computer receiving an electronic request to complete service of process from a client computer, the request comprising a document recipient, a document recipient address, and a selection of timing options for completing service of process;
the computer receiving a legal document electronically from the client computer;
the computer displaying the service of process request to a plurality of unaffiliated process servers;
the computer receiving, from a process server computer, an application to complete the service of process request by serving the legal document to the document recipient;
the computer receiving, from the client computer, an electronic selection of a process server to complete the service of process request;
the computer transmitting the legal document electronically to the process server computer;
the computer transmitting instructions regarding service of process to the process server computer;
the computer receiving electronic confirmation of service of process from the process server computer to confirm completion of service of process of the legal document to the document recipient; and
the computer transmitting to the client electronic proof of service of process.

12. The method of claim 11, further comprising:
the computer receiving data regarding the plurality of unaffiliated process servers, data sufficient to create a process server account on the computer for each of the plurality of process servers; and
the computer receiving, from a client computer, data sufficient to create a client account on the computer.

13. The method of claim 11, wherein the electronic request to complete service of process comprises an electronic photo of the document recipient and service of process instructions specific to the document recipient.

14. The method of claim 11, wherein the method comprises:
the computer electronically transmitting information regarding a process server to the client computer;
the computer receiving a section of a process server from the client computer; and
the computer transmitting electronic notification of acceptance of the service of process request to a process server computer associated with the selected process server.

15. The method of claim 11, wherein the step of the computer transmitting instructions regarding service of process to the process server computer comprises:
the computer displaying, via the process server computer, a map showing the document recipient location; and
the computer transmitting, to the process server computer, navigation instructions to lead the process server to the document recipient.

16. The method of claim 11, wherein the step of the computer transmitting instructions regarding service of process to the process server computer comprises:
the computer displaying, via the process server computer, a map showing the process server location and showing the document recipient location; and
the computer transmitting, to the process server computer, navigation instructions to lead the process server to the document recipient in real time.

17. The method of claim 16, wherein the method comprises:
the computer tracking the movement of the process server computer in real time while the process server is in the process of serving the legal document to the document recipient.

18. The method of claim 11, wherein the method comprises:
the computer receiving electronic confirmation of service of process comprising GPS location data of the process server computer at a time when service of process occurred; and
the computer transmitting, to the client computer, electronic proof of service of process comprising GPS location data of the process server computer at the time when service of process occurred.

19. The method of claim 11, wherein the method comprises:
the computer receiving electronic confirmation of service of process comprising a signature obtained electronically from the document recipient during completion of service of process; and
the computer transmitting, to the client computer, electronic proof of service of process comprising the signature obtained electronically from the document recipient during completion of service of process.

20. The method of claim 11, wherein the method comprises:
the computer receiving electronic confirmation of service of process comprising photographic evidence of completion of service of process; and
the computer transmitting, to the client computer, electronic proof of service of process comprising the photographic evidence of completion of service of process.
